(19) United States
(12) Patent Application Publication
(10) Pub. No.: US 2008/0228918 A1
(43) Pub. Date: Sep. 18, 2008

(54) DOWNLOAD SERVER DETERMINATION METHOD AND RECORD MEDIUM BEARING DOWNLOAD SERVER DETERMINATION PROGRAM

(75) Inventor: Hirotaka Shimizu, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/043,560

(22) Filed: Mar. 6, 2008

(30) Foreign Application Priority Data
Mar. 14, 2007 (JP) 2007-65142

(51) Int. Cl. G06F 15/16

(52) U.S. Cl. 709/225

(57) ABSTRACT

A computer determines a download server for downloading contents into a terminal device from among a plurality of servers storing the identical contents therein, by accepting a download request for the contents from the terminal device, detecting a time at which the download request was accepted and determining the download server in accordance with the detected time.

### BACKGROUND

Websites which serve as access destinations for downloading the identical contents are sometimes constituted by a regular site and mirror sites. The regular site and mirror sites disperse a processing load when contents are provided to many and unspecified Web users by employing an HP (homepage) laid open on the Web. Each of the regular site and the mirror sites is operated by one or more download servers. Each of the regular site and the mirror sites is guided by a hypertext containing URL (Uniform Resource Locator) information as is laid open in the HP on the Web.

A guide display screen concerning the download of contents in the related art will be concretely outlined with reference to FIG. 10. FIG. 10 is an explanatory diagram showing an example of the guide display screen which concerns the download of the contents in the related art.

Referring to FIG. 10, the guide display screen 1000 is displayed on a display unit (not shown) at the terminal of a Web user by accessing an HP laid open on the Web, and it indicates hypertexts 1001, 1002 and 1003.

The hypertext 1001 contains the URL information of a regular site, and the Web user can access the regular site by selecting this hypertext through the manipulation of a mouse or the like, (not shown). The regular site stores the contents to-be-downloaded therein so as to be capable of providing them, and the Web user can download the contents by accessing the regular site.

The hypertexts 1002 and 1003 contain the URL information items of a mirror site 1 and a mirror site 2, respectively. The Web user can access the mirror site 1 or the mirror site 2 by selecting the corresponding hypertext through the manipulation of the mouse or the like, (not shown). The mirror site 1 or the mirror site 2 stores the contents to-be-downloaded therein so as to be capable of providing them, and the Web user can download the contents by accessing the mirror site 1 or the mirror site 2.

In this manner, the Web user can access the regular site or the mirror site and then download the contents by selecting any of the hypertexts 1001, 1002 and 1003. Thus, access destinations are respectively selected by the individual Web users, and hence, a load based on the downloading accesses is dispersed, even when the contents are provided to many and unspecified Web users.

With the related-art technique, however, the decision as to whether the regular site or the mirror site is accessed is left to the judgment of each Web user. Consequently, there has been the problem that the load is not favorably dispersed when the selections of the accesses have been concentrated partially on any of the sites.

In particular, when the sites are guided by the character information of the “regular site” and the “mirror site”, the Web users often select the “regular site”, because it is considered to be a formal site. As a result, the Web user selects the “mirror site” anew and accesses this mirror site you are in a he/she has accessed the “regular site” and has found downloading the contents to be difficult. Therefore, a pleasant download environment cannot be provided.

Moreover, in a case where the Web user is a beginner who is unaccustomed to the download, he/she is puzzled by the decision as to whether the regular site is to be accessed or the mirror site is to be accessed. This forms a factor for hampering a pleasant Web use.

Besides, in recent years, a server load dispersion system has been proposed in JP-A-2004-304698. Here, the load information items of a main server and a mirror server which provide the program homepage of a broadcasting program are collected periodically. The Web user is connected to the program homepage in accordance with any URL information extracted from within a server URL table which is altered in accordance with the load information items of the individual servers,

However, even in a case where the information items of loads on the individual servers are collected and where the server URL table is so altered that the server of heavier load cannot be accessed, users who did not access the site after the increase of the load cannot perform a pleasant download. That is, after one server has been loaded, the other server is deflected, so that a pleasant download environment cannot be provided in real time.

Moreover, since the server is accessed on the basis of the server URL table, which has been altered in accordance with the information items of the loads of the servers, the Web user who has received the server URL table might access the server of the heavier load. The Web user might access the server of the heavier load because of the fluctuation of a load when is a he/she does not access the server immediately after the reception. Therefore, the loads are not dispersed appropriately,

### SUMMARY

According to an aspect of an embodiment, a download server determination method wherein a computer determines a download server for downloading contents into a terminal device, from among a plurality of servers storing the identical contents therein, comprises the operations of:

accepting a download request for the contents, from the terminal device;

detecting a time at which the download request was accepted; and

determining the download server in accordance with the detected time.

The above-described embodiments of the present invention are intended as examples, and all embodiments of the present invention are not limited to including the features described above.

### BRIEF DESCRIPTION OF THE DRAWINGS

FIG. 1 is an explanatory diagram showing the outline of a download server determination system according to an embodiment of the present invention;

FIG. 2 is a block diagram showing the hardware configuration of a computer apparatus according to the embodiment of the invention;

FIG. 3 is an explanatory diagram showing the functional configuration of the download server determination system according to the embodiment of the invention;

FIG. 4 is an explanatory diagram showing an example of the display screen of a client terminal according to the embodiment of the invention;

FIG. 5 is an explanatory diagram showing the outline of a schedule table according to the embodiment of the invention;

FIG. 6 is an explanatory diagram showing the outline of the determination of a download (DL) site according to the embodiment of the invention;

FIG. 7 is a flow chart showing processing operations for incorporating an applet into a hypertext, according to the embodiment of the invention;

FIG. 8 is a flow chart showing processing operations for editing the applet, according to the embodiment of the invention;

FIG. 9 is a flow chart showing processing operations for determining the DL site, according to the embodiment of the invention; and

FIG. 10 is an explanatory diagram showing an example of a guide display screen which concerns the download of contents in the related art.

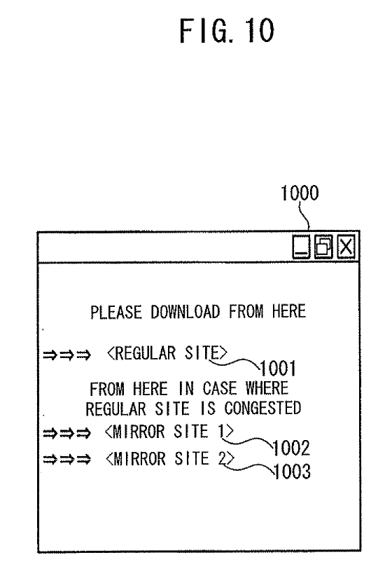

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Outline of Download Server Determination System

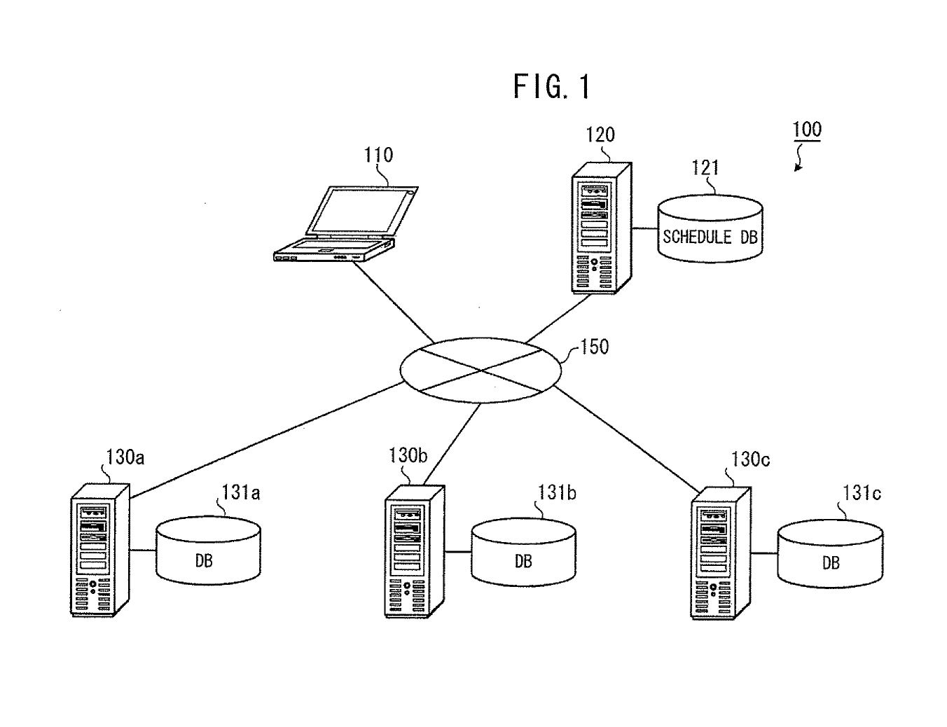

First, a download server determination system according to an embodiment of the present invention will be outlined with reference to FIG. 1. FIG. 1 is an explanatory diagram showing the outline of the download server determination system according to the embodiment of the invention.

Referring to FIG. 1, the download server determination system 100 according to the embodiment of the invention is such that a client terminal 110, a Web server 120 and servers 130 (130a, 130b and 130c) are connected by a network 150 such as the Internet.

The client terminal 110 is a computer apparatus which can access Web sites operated by the Web server 120, through the network 150. Concretely, by way of example, the user of the client terminal 110 can browse an HP, etc. which are laid open on a Web by the Web server 120, by employing the client terminal 110.

Besides, the client terminal 110 can access download (DL) sites operated by the servers 130 (130a, 130b and 130c), through the network 150. Concretely, by way of example, the user of the client terminal 110 can download contents provided by the servers 130 (130a, 130b and 130c), by employing the client terminal 110.

The contents are, for example, image data, text data and the data of various programs, and they are stored in DBs (databases) 131 (131a, 131b and 131c) to be explained later.

More concretely, by way of example, the client terminal 110 can access the selected DL site and download contents when a hypertext which contains the URL information of a DL site and which is displayed on the display screen of the client terminal 110 is selected by the client terminal 110.

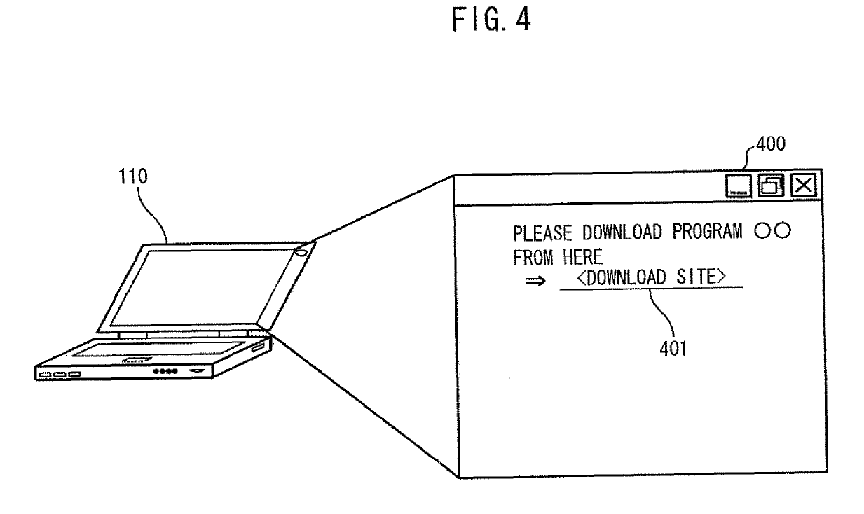

As will be detailed with reference to FIG. 4, the hypertext is indicated on, for example, an HP laid open on a Web site. The user of the client terminal 110 can access the DL site and download the contents by an applet incorporated in the hypertext when he/she selects the hypertext by manipulating a mouse or the like, (not shown).

That is, owing to the applet incorporated in the selected hypertext, the user jumps to the DL site operated by a download server for downloading the contents and determined from among the servers 130 (130a, 130b and 130c), and he/she downloads the contents. Besides, processing based on the applet incorporated in the hypertext may well determine the DL site, instead of determining the download server from among the servers 130 (130a, 130b and 130c).

The Web server 120 is a computer apparatus which includes a schedule DB 121, and which lays open Web sites on the Web. Concretely, by way of example, the Web sites are an HP, etc. accessible by the client terminal 110, and they lay open hypertexts or the likes indicating the download destinations of contents.

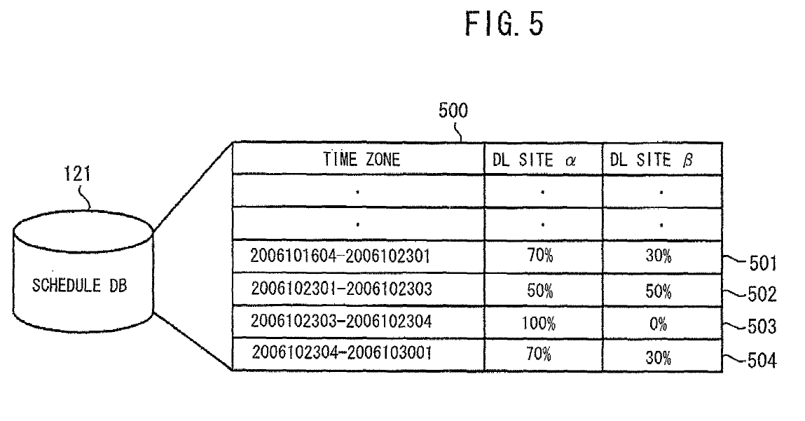

The schedule DB 121 stores therein a schedule table for use in the applet which is incorporated into the hypertext. As will be detailed with reference to FIG. 5, the schedule table is, for example, a table in which weights concerning the downloads in the DL sites operated by the servers 130 (130a, 130b and 130c) are recorded in association with time zones.

The servers 130 (130a, 130b and 130c) are computer apparatuses which include the respective DBs 131 (131a, 131b and 131c), and which operate the DL sites whose contents can be downloaded by the client terminal 110.

The DBs 131 (131a, 131b and 131c) store, for example, the contents to-be-downloaded therein. Concretely, by way of example, the client terminal 110 can download the contents stored in the DBs 131 (131a, 131b and 131c), by accessing the DL sites operated by the servers 130 (130a, 130b and 130c).

Incidentally, although the Web server 120 and the servers 130 (130a, 130b and 130c) have been described as different apparatuses in conjunction with FIG. 1, they may well be an identical apparatus. Concretely, by way of example, the download sites whose contents can be downloaded by the client terminal 110 may well be operated by the Web server 120, or the Web sites may well be laid open by the servers 130 (130a, 130b and 130c).

Besides, although the single client terminal 110 has been described in conjunction with FIG. 1, a plurality of client terminals may well be existent. That is, the HP laid open on the Web by the Web server 120 may well be accessible by many and unspecified client terminals 110.

Further, although the single Web server 120 has been described, a plurality of Web servers may well be existent. That is, the client terminal 110 can access any of HPs laid open on the Web by the plurality of Web servers 120.

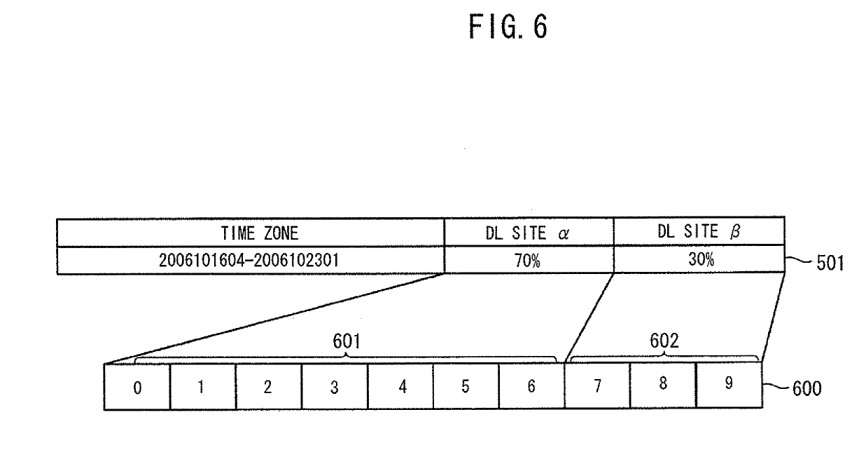

Likewise, the number of the servers 130 (130a, 130b and 130c) need not be limited to three, but it may well be smaller than three, or it may well be four or more. Besides, the DL site may well be operated by one or more of the servers 130 (130a, 130b and 130c). Concretely, by way of example, a DL site cc and a DL site P shown in FIGS. 5 and 6 are respectively operated by the servers 130a and 130b and by the server 130c.

Hardware Configuration of Computer Apparatus

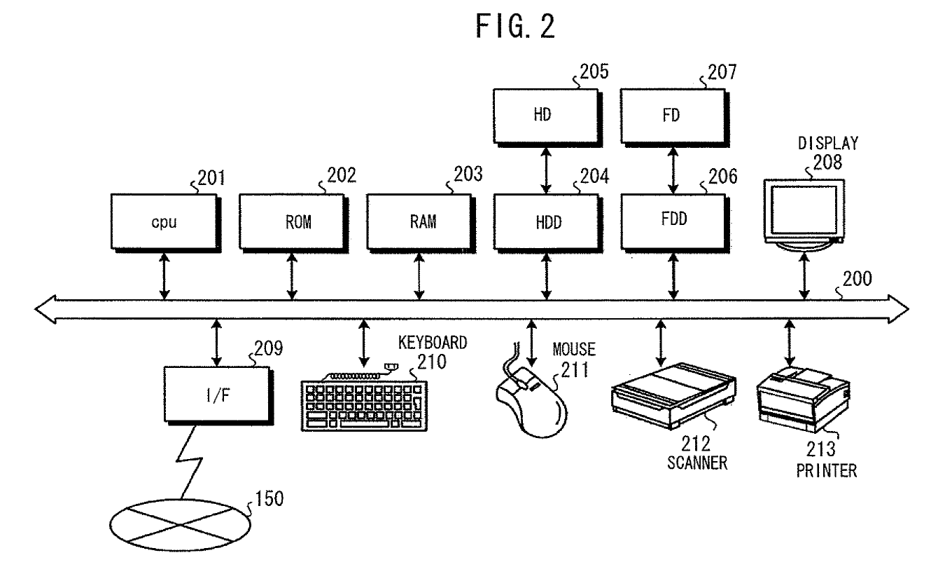

Next, the hardware configuration of the computer apparatus shown in FIG. 1 will be described with reference to FIG. 2. FIG. 2 is a block diagram showing the hardware configuration of the computer apparatus according to the embodiment of the invention.

Referring to FIG. 2, the computer apparatus includes a CPU 201, a ROM 202, a RAM 203, an HDD (hard disk drive) 204, an HD (hard disk) 205, an FDD (flexible disk drive) 206, an FD (flexible disk) 207 being an example of a detachable record medium, a display 208, an I/F (interface) 209, a keyboard 210, a mouse 211, a scanner 212 and a printer 213. Besides, the individual constituents are interconnected by a bus 200.

Here, the CPU 201 governs the general control of the computer apparatus. The ROM 202 stores therein programs such as a boot program. The RAM 203 is used as the work area of the CPU 201. The HDD 204 controls the read/write of data from/into the HD 205 in accordance with the control of the CPU 201. The HD 205 stores therein the data written by the control of the HDD 204.

The FDD 206 controls the read/write of data from/into the FD 207 in accordance with the control of the CPU 201. The FD 207 stores therein the data written by the control of the FDD 206, and the computer apparatus is caused to read the data stored in the FD 207.

Besides, apart from the FD 207, the detachable record medium may well be a CD-ROM (CD-R or CD-RW), an MO, a DVD (Digital Versatile Disk), a memory card or the like. The display 208 displays a cursor, icons or a tool box, and also the data of a document, an image, functional information etc. A CRT, a TFT liquid-crystal display or a plasma display, for example, can be adopted as the display 208.

The I/F 209 is connected to the Internet or a similar network 150 through a communication line, and it is connected to another apparatus through the network 150. In addition, the I/F 209 governs the interface between the network 150 and the interior of the computer apparatus, and it controls the input/output of data from the external apparatus. A modem or a LAN adaptor, for example, can be adopted as the I/F 209.

The keyboard 210 includes keys for inputting characters, numerals, various instructions, etc., and it inputs data. Besides, the keyboard 120 may well be replaced with an input pad of touch panel type, a ten-key device, or the like. The mouse 211 moves the cursor or selects a range, or moves a window or alters a size, by way of example. Besides, the mouse 211 may well be replaced with a track ball, a joystick or the like as long as it has similar functions as a pointing device.

The scanner 212 reads an image optically and accepts image data into the computer apparatus. Incidentally, the scanner 212 may well be endowed with an Optical Character Recognition (OCR) function. Besides, the printer 213 prints image data and document data. A laser printer or an inkjet printer, for example, can be adopted as the printer 213.

Functional Configuration of Download Server Determination System 100

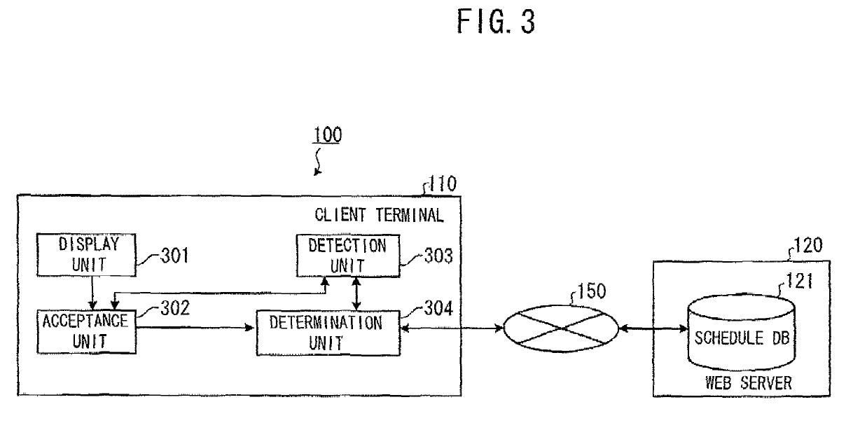

Subsequently, the functional configuration of the download server determination system 100 according to the embodiment of the invention will be described with reference to FIG. 3. FIG. 3 is an explanatory diagram showing the functional configuration of the download server determination system according to the embodiment of the invention.

Referring to FIG. 3, the download server determination system 100 is configured of the client terminal 110 and the Web server 120. The client terminal 110 and the Web server 120 are connected through the network 150.

The client terminal 110 is configured of a display unit 301, an acceptance unit 302, a detection unit 303 and a determination unit 304. Besides, the Web server 120 includes the schedule DB 121.

The display unit 301 displays the HP laid open on the Web by the Web server 120, and concretely, the function is implemented by, for example, the display 208 shown in FIG. 2. As will be detailed with reference to FIG. 4, the display of the HP displays, for example, a hypertext containing the URL information of a DL site from which contents can be downloaded.

Concretely, by way of example, the display unit 301 displays a single hypertext concerning the download of contents. Owing to such a display, the user of the client terminal 110 is not confused by a plurality of hypertexts.

More concretely, by way of example, the display unit 301 stores the information of the HP acquired through the network 150, in a memory such as the ROM 202 or the RAM 203, and it displays the information on the display 208 in accordance with the control of the CPU 201.

The acceptance unit 302 accepts a download request for the contents. Concretely, by way of example, the acceptance unit 302 accepts the download request for the contents in such a way that the single hypertext displayed on the display 208 is selected by the user's manipulation of the keyboard 210, the mouse 211 or the like.

More concretely, by way of example, the acceptance unit 302 stores information indicating the effect that the single hypertext displayed on the display 208 has been selected, in the memory such as ROM 202 or RAM 203, in accordance with the control of the CPU 201. The information indicating the effect that the hypertext has been selected is read out in accordance with the control of the CPU 201 as needed.

The detection unit 303 detects a time at which the download request was accepted by the acceptance unit 302. Concretely, by way of example, the detection unit 303 detects the time at which the single hypertext displayed on the display 208 was selected by the user's manipulation of the keyboard 210, the mouse 211 or the like, from a time measured by a timekeeping unit (not shown).

More concretely, by way of example, the detection unit 303 stores the information of the time when the information indicating the effect that the hypertext has been selected is stored in the memory such as ROM 202 or RAM 203, in the pertinent memory. The information of the time is read out in accordance with the control of the CPU 201 as needed.

The determination unit 304 determines the download server for downloading the contents from among the plurality of servers which store the identical contents. The DL server is selected on the basis of the time detected by the detection unit 303. Concretely, by way of example, the determination unit 304 determines the download server operating the DL site from which the client terminal 110 downloads the contents from among the servers 130 (130a, 130b and 130c) which include the respective DBs 131 (131a, 131b and 131c) storing the identical contents therein, as shown in FIG. 1.

More concretely, by way of example, the determination unit 304 determines the download server by using the information of the time and the information indicating the selection of the hypertext as is stored in the memory such as ROM 202 or RAM 203, and it stores information on the determined download server in the memory such as ROM 202 or RAM 203. The information on the download server is read out in accordance with the control of the CPU 201 as may be needed.

Besides, as will be detailed with reference to FIGS. 5 and 6, the determination unit 304 determines the download server on the basis of numerals allotted to the respective servers 130 (130a, 130b and 130c), and the time detected by the detection unit 303.

Concretely, by way of example, the determination unit 304 determines the server 130 (130a, 130b or 130c) to which the right most numeral of the seconds of the time detected by the detection unit 303 is assigned, as the download server from among the plurality of servers 130 (130a, 130b and 130c). The numerals allotted to the respective servers (130a, 130b and 130c) are allotted in correspondence with, for example, weights concerning the downloads of the contents. Incidentally, although the right most numeral of the seconds of the time is used here, any of numerals indicating the time (for example, an hour, minutes and the seconds) may be used.

The weights concerning the downloads are acquired by fetching a schedule table stored in the schedule DB 121 whose function is implemented by, for example, the HD 205 or the FD 207 shown in FIG. 2. The schedule table is a table indicating proportions at which the client terminal 110 is guided to the DL sites in accordance with, for example, the performances and operation schedules of the servers 130 (130a, 130b and 130c) operating the DL sites.

The determination unit 304 may well determine the DL site from which the client terminal 110 downloads the contents, instead of determining the download server. The case of determining the DL site will be described below.

Incidentally, the functional constituents of the download server determination system 100 have been described as the client terminal 110 and the Web server 120 in conjunction with FIG. 3, but in a case where the client terminal 110 stores the schedule table therein, the function of the download server determination system 100 may well be exhibited by the client terminal 110.

By the way, the functions of the acceptance unit 302, detection unit 303 and determination unit 304 described above with reference to FIG. 3 are concretely implemented, for example, in such a way that a program recorded in a record medium such as the ROM 202, RAM 203 or HD 205 shown in FIG. 2 is run by the CPU 201.

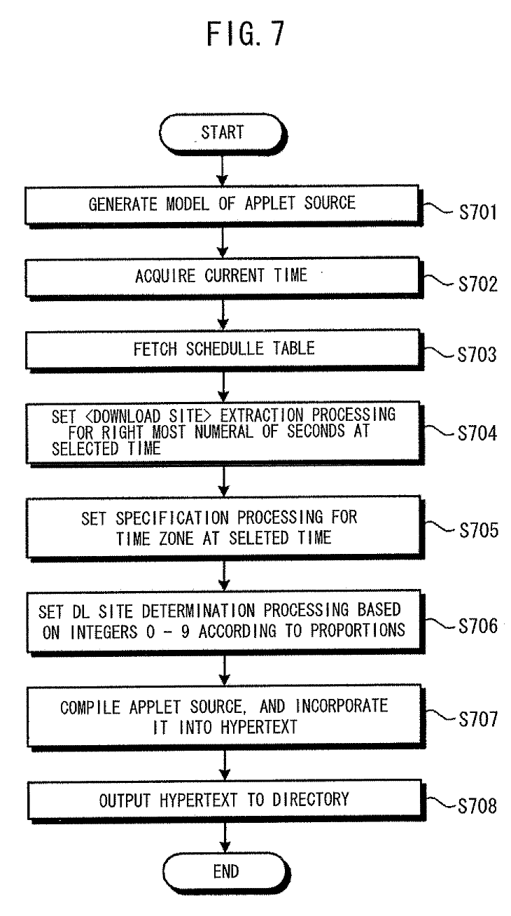

More concretely, by way of example, the functions are implemented by running an applet which is incorporated in the hypertext displayed on the display unit 301. As will be detailed with reference to FIGS. 7 to 9, the applet is, for example, the program which causes the acceptance unit 302 to accept the selection of the hypertext, the detection unit 303 to detect the time, and the determination unit 304 to determine the DL site in which the numeral obtained by extracting the right most numeral of the seconds of the time becomes the same as the numeral allotted by the weight of the schedule containing the time detected from within the schedule table. Besides, although no illustration is made, the applet may well be such that the determined DL site is automatically accessed.

Outline of Display Screen

Here, the display screen of the client terminal 110 in the download server determination system 100 according to the embodiment of the invention will be described with reference to FIG. 4. FIG. 4 is an explanatory diagram showing an example of the display screen of the client terminal according to the embodiment of the invention.

Referring to FIG. 4, the display screen 400 is displayed on the display 208 of the client terminal 110. Concretely, by way of example, a hypertext 401 containing the URL information of the download site of contents as is guided on an HP laid open by the Web server 120 shown in FIG. 1 is displayed on the display screen 400.

An applet which is activated when information <Download Site> indicated by the hypertext 401 is selected, is incorporated in this hypertext 401. The selection of the information <Download Site> is done, for example, in such a way that the user of the client terminal 110 manipulates the keyboard 210 or the mouse 211 shown in FIG. 2.

Concretely, by way of example, the applet is such a program that, when the information <Download Site> is selected, the right most numeral of the seconds of the time of the selection is extracted. Further, a time zone containing the selection time, in a schedule table is specified. In addition, the DL site is determined in accordance with the extracted numeral and a numeral corresponding to the schedule of the specified time zone, and the pertinent DL site is accessed.

Outline of Schedule Table

Next, a schedule table in the download server determination system 100 according to the embodiment of the invention will be outlined with reference to FIG. 5. FIG. 5 is an explanatory diagram showing the outline of the schedule table according to the embodiment of the invention.

Referring to FIG. 5, the schedule table 500 is stored in the schedule DB 121 shown in FIG. 1, and it indicates weights concerning the downloads of contents in predetermined time zones. Concretely, by way of example, the schedule table 500 is configured of schedules 501, 502, 503 and 504 indicating proportions at which the accesses of the client terminal 110 to DL sites (DL site α and DL site P) permitting the downloads of the contents are allowed.

In other words, the schedule table 500 indicates those proportions of the DL site α and DL site β at which the information <Download Site> shown in FIG. 4 is selected by the client terminal 110 in order to download the contents, and at which these DL sites are accessed.

Besides, the time zone indicates the zone of the date and hour, minute and seconds. By way of example, “2006101604-2006102301” in the schedule 501 signifies a zone from 4 o'clock on October 16 in 2006, to 1 o'clock on October 23 in 2006.

The proportions for the DL site α and DL site β in the respective time zones in the schedules 501, 502, 503 and 504 may well be set in accordance with the performances, the scheduled operations, etc. of the servers 130a, 130b and 130c which operate the DL site α and DL site β. In the description of FIG. 5, there will be mentioned a case where, using the servers 130a, 130b and 130c of equivalent performances as shown in FIG. 1, the DL site α is operated by the servers 130a and 130b, while the DL site β is operated by the server 130c.

Concretely, by way of example, it is assumed regarding the scheduled operation of the DL site α that the servers 130a and 130b are maintained one by one from 1 o'clock to 3 o'clock on October 16 in 2006 and on October 23 in 2006, so the DL site α is operated by one server. In addition, it is assumed regarding the scheduled operation of the DL site β that the server 130c is maintained from 3 o'clock to 4 o'clock on October 16 in 2006 and on October 23 in 2006, so the operation of the DL site β is stopped.

In case of such scheduled operations, any maintenance is not performed in the schedules 501 and 504 which fall outside the time zones of from 1 o'clock to 3 o'clock on October 16 in 2006 and on October 23 in 2006, and from 3 o'clock to 4 o'clock on October 16 in 2006 and on October 23 in 2006. In each of these schedules 501 and 504, accordingly, the proportion of the DL site α operated by the two servers 130a and 130b is set higher than the proportion of the DL site β operated by one server 130c.

Besides, in the schedule 502 of the time zone of from 1 o'clock to 3 o'clock on October 23 in 2006, in which one of the servers 130a and 130b operating the DL site α is maintained, each of the DL sites α and β is operated by one server, and both the DL sites α and β are set at the same proportions.

Further, in the schedule 503 of the time zone of from 3 o'clock to 4 o'clock on October 23 in 2006, in which the server 130c operating the DL site β is maintained, the DL site β is not operated, and the proportion of the DL site α is set at 100%, whereas the proportion of the DL site β is set at 0%.

When the proportions of the DL sites α and β which are accessed by the client terminal 110 are set by employing such a schedule table 500, an optimal download environment can be provided without investigating the situation of the loads of the servers 130a, 130b and 130c, even in the case of performing the maintenances of the servers 130a and 130b and the server 130c which operate the respective DL sites α and β.

Besides, although the proportions in the schedules 501, 502, 503 and 504 have been set in accordance with the operation schedules of the servers 130a, 130b and 130c in the description of FIG. 5, they may well be set in accordance with the performances of the servers 130a, 130b and 130c.

Concretely, by way of example, the proportions in schedules 501, 502, 503 and 504 are set high when the servers 130a, 130b and 130c are of high performances, and they are set low when these servers are of low performances. In this way, an optimal download environment which corresponds to the performances of the servers 130a, 130b and 130c operating the DL sites α and β can be provided.

Further, although the schedules of the preset maintenances have been mentioned in the description of FIG. 5, the schedule table 500 may well be rewritten in case of an emergency maintenance, the occurrence of any disorder in the server 130a, 130b or 130c, or the like. In this manner, the situation of the servers 130a, 130b and 130c is appropriately coped with, whereby the user of the client terminal 110 can always download contents from the optimal DL site.

Outline of Determination of DL Site

Next, the determination of a DL site in the download server determination system 100 according to the embodiment of the invention will be outlined with reference to FIG. 6. FIG. 6 is an explanatory diagram showing the outline of the determination of the DL site according to the embodiment of the invention. Incidentally, the schedule 501 shown in FIG. 5 will be used in the description of FIG. 6.

Referring to FIG. 6, the determination of the DL site in the schedule 501 is done in accordance with the integers 600 of “0”-“9” corresponding to the proportions of the DL sites α and β set in the schedule 501.

Regarding the allotment of the integers, by way of example, the integers 601 of “0”-“6” are allotted to the DL site a whose proportion is set at 70%, and the integers 602 of “7”-“9” are allotted to the DL site β whose proportion is set at 30%.

Concretely, by way of example, in the determination of the DL site, the schedule table of the time zone at and after a time at which a HP provided by the Web server 120 was browsed is fetched by the client terminal 110 shown in FIG. 1. In addition, the DL site is determined by comparing the integers 601 and 602 allotted in accordance with the proportions of the DL sites α and β set in the schedule 501 containing a selection time at which the information <Download Site> was selected, and the right most numeral of the seconds of the selection time.

More concretely, by way of example, in the determination of the DL site, in a case where the information <Download Site> was selected at 9 o'clock 22 minutes 24 seconds on October 18 in 2006, the right most numeral of the seconds of the selection time is “4”, and hence, the DL site α to which the integers 601 containing the numeral “4” are allotted is determined. Likewise, in a case where the information <Download Site> was selected at 15 o'clock 25 minutes 48 seconds on October 19 in 2006, the right most numeral of the seconds of the selection time is “8”, and hence, the DL site β to which the integers 602 containing the numeral “8” are allotted is determined.

In this manner, the DL site is determined using the number of seconds of the selection time at which the information <Download Site> was selected, and the integers 601 and 602, whereby the DL site can be determined easily and exactly. That is, a processing load ascribable to a process for generating pseudo-random numbers correspondent to the proportions set for the DL sites α and β is removed, and the deviation of a probability attributed to the process for generating the pseudo-random numbers can be prevented.

Besides, the DL site is determined using the number of seconds of the selection time and the integers 601 and 602, whereby the sides of the servers 130 (130a, 130b and 130c) need not analyze the number of the client terminals 110 having accessed the DL sites, etc., and the increases of the loads of the servers 130 (130a, 130b and 130c) can be prevented,

In addition, the DL sites can be determined in adaptation to the operation schedules of the servers 130 (130a, 130b and 130c) without collecting the situation of the loads on these servers 130 (130a, 130b and 130c).

Incidentally, although the right most numeral of the seconds of the selection time has been used in the description of FIG. 6, any numeral which exists at the same probability at the selection of the information <Download Site> may be used. Concretely, by way of example, a numeral indicating first decimal place of the seconds of the selection time may well be used. Thus, even in a case where accesses concentrate in a very short time (for example, in several seconds), the DL sites can be appropriately determined.

Besides, the integers 601 and 602 allotted in correspondence with the proportions of the DL sites α and β need not be continuous as “0”-“6” and “7”-“9”, but they may well be allotted so that the numbers of numerals may become 7 to 3. Concretely, by way of example, (“0”-“3” and “7”-“9”) are allotted as the integers 601, and (“4”-“6”) are allotted as the integers 602.

Processing Operations for Incorporating Applet

Next, processing operations for incorporating an applet into a hypertext in the download server determination system 100 according to the embodiment of the invention will be described with reference to FIG. 7. FIG. 7 is a flow chart showing the processing operations for incorporating the applet into the hypertext according to the embodiment of the invention. Incidentally, it is assumed in the description of FIG. 7 that the applet is incorporated into the hypertext by the Web server 120 shown in FIG. 1, but the applet may well be incorporated by the client terminal 110.

Referring to the flow chart of FIG. 7, first of all, the model of an applet source to be incorporated into the hypertext is generated by the CPU 201 (operation S701). The generation of the model of the applet source is done, for example, when an access has been made from the client terminal 110 to an HP.

Subsequently, a current time in the case of generating the applet source at the operation S701 is acquired by the CPU 201 (operation S702). The acquisition of the current time may well be done by, for example, a timekeeping unit not shown, and the time at which the access was made from the client terminal 110 to the HP is detected.

Subsequently, the schedule table 500 which contains a time zone at and after the current time acquired at the operation S702 is fetched from the schedule DB 212 (operation S703).

In addition, extraction processing for the right most numeral of the seconds at the selection time of information <Download Site> indicated in the hypertext 401 is set in the model of the applet source generated at the operation S701, by the CPU 201 (operation S704). Concretely, by way of example, the extraction processing is processing in which, when the information <Download Site> indicated by the hypertext 401 on the HP displayed by the client terminal 110 is clicked by the mouse 211, the right most numeral of the seconds of the click time is extracted.

Subsequently, specification processing for the time zone at the selection time is set in the model of the applet source generated at the operation S701, on the basis of the schedule table 500 fetched at the operation S703, by the CPU 201 (operation S705). Concretely, by way of example, the specification processing is processing for specifying the time zone containing the time at which the information <Download Site> indicated by the hypertext 401 on the HP displayed by the client terminal 110 was clicked by the mouse 211.

Further, DL site determination processing based on the integers of “0”-“9” corresponding to the proportions of the individual DL sites in the schedule table 500 is set in the model of the applet source generated at the operation S701, by the CPU 201 (operation S706).

Concretely, by way of example, the DL site determination processing allots the integers 601 and 602 of “0”-“9” as shown in FIG. 6, in accordance with the proportions of the time zone specified by the execution of the specification processing set at the operation S705. In addition, the DL site to which the numeral extracted by the execution of the extraction processing set at the operation S704 has been allotted is determined.

Subsequently, the applet source in which the several items of processing have been set at the operations S704-S706 is compiled and is incorporated into the hypertext 401 by the CPU 201 (operation S707). In addition, the resulting hypertext is outputted to a directory to be laid open to the client terminal 110 (operation S708). Then, the series of processing operations for incorporating the applet are ended.

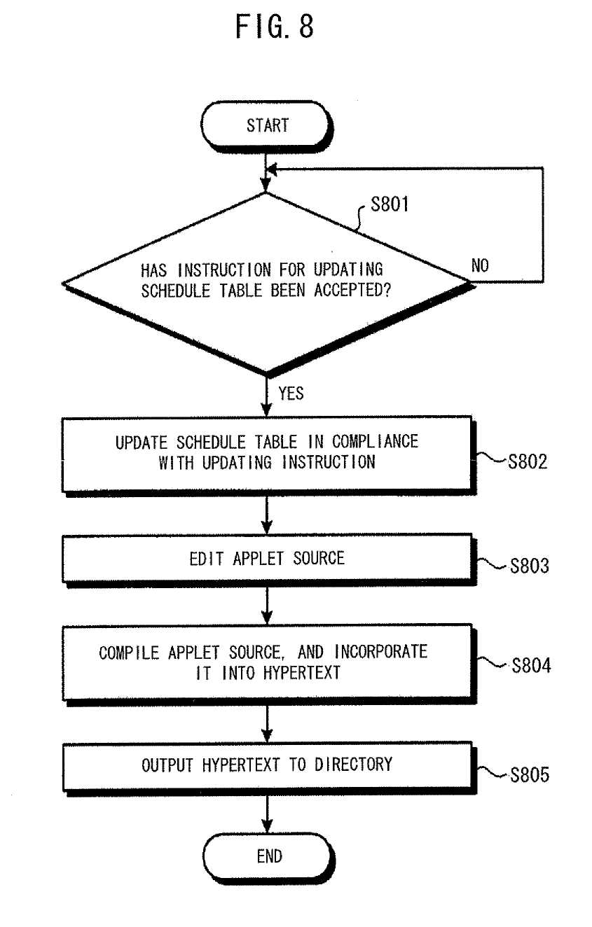

Processing Operations for Editing Applet)Subsequently, processing operations for editing the applet in the download server determination system 100 according to the embodiment of the invention will be described with reference to FIG. 8. FIG. 8 is a flow chart showing the processing operations for editing the applet according to the embodiment of the invention.

Referring to the flow chart of FIG. 8, first of all, whether or not an instruction for updating the schedule table 500 has been accepted is judged (operation S801). The updating instruction may well be given by accepting an input with, for example, the keyboard 210 or the mouse 211, or by receiving an input through the network 150 by the I/F 209. Concretely, by way of example, the updating of the schedule table 500 is done in a case where the schedule of the operation of the server 130 (130a, 130b or 130c) operating the DL site has been altered.

in a case where, at the operation S801, the updating instruction was waited and was accepted (operation S801: Yes), the schedule table 500 is updated in compliance with the updating instruction accepted at the operation S801, by the CPU 201 (operation S802).

Subsequently, the applet source to be incorporated into the hypertext 401 is edited using the schedule table 500 updated at the operation S802, by the CPU 201 (operation S803). Concretely, by way of example, the editing of the applet source is such that the updated schedule table 500 is fetched at the operation S703 shown in FIG. 7, and that the several items of processing at the operations S704-S706 are set.

Subsequently, the applet source edited at the operation S803 is compiled and is incorporated into the hypertext 401 by the CPU 201 (operation S804). In addition, the resulting hypertext is outputted to a directory to be laid open to the client terminal 110 (operation S805). Then, the series of processing operations for editing the applet are ended.

Processing Operations for Determining DL Site

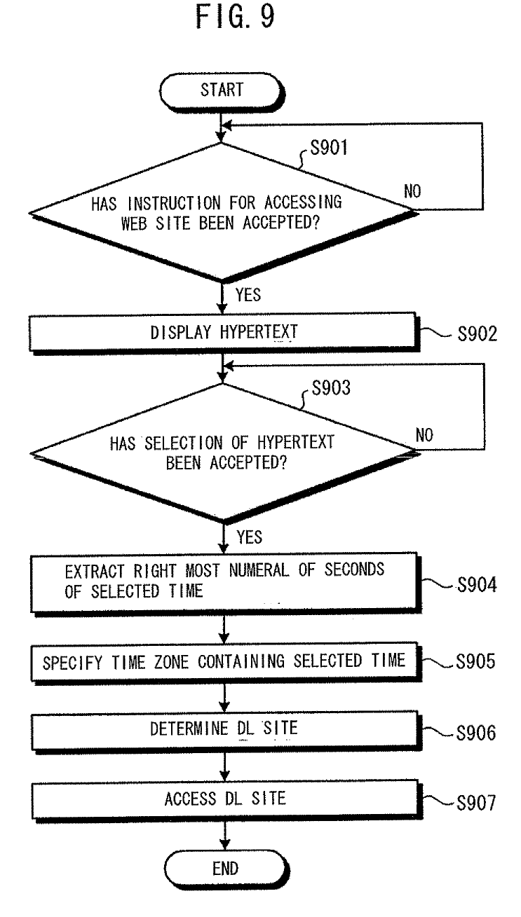

Next, processing operations for determining the DL site in the download server determination system 100 according to the embodiment of the invention will be described with reference to FIG. 9. FIG. 9 is a flow chart showing the processing operations for determining the DL site according to the embodiment of the invention. By the way, in the description of FIG. 9, there will be mentioned a case of determining the DL site which is accessed in downloading contents by the client terminal 110 shown in FIG. 1.

Referring to the flow chart of FIG. 9, first of all, whether or not an instruction for accessing a Web site has been accepted is judged (operation S901). The access instruction may well be given by accepting an input with, for example, the keyboard 210 or the mouse 211, and the user of the client terminal 110 browses an HP or the like by accessing the Web site.

In a case where, at the operation S901, the access instruction was waited and was accepted (operation S901: Yes), the hypertext 401 laid open on the HP instructed to be accessed at the operation S901 is displayed by the display unit 301 (operation S902).

Subsequently, whether or not the selection of the hypertext 401 displayed at the operation S902 has been accepted is judged by the acceptance unit 302 (operation S903). Concretely, by way of example, the selection of the hypertext is done in such a way that the information <Download Site> indicated by the single hypertext is clicked by the user's manipulation of the mouse 211 or the like.

In a case where, at the operation S903, the selection of the hypertext 401 was waited and was accepted (operation S903: Yes), the applet incorporated in the hypertext 401 is activated by the determination unit 304, so as to extract the right most numeral of the seconds of the time of the selection of the hypertext 401 at the operation S903 (operation S904). That is, the extraction processing set at the operation S704 shown in FIG. 7 is executed.

Subsequently, a time zone which contains the selection time of the hypertext 401 at the operation S903 is specified by the activation of the applet by the determination unit 304 (operation S905). That is, the specification processing set at the operation S705 shown in FIG. 7 is executed.

In addition, the DL site from which the contents are downloaded is determined by the activation of the applet by the determination unit 304 (operation S906). That is, the DL site determination processing set at the operation S706 shown in FIG. 7 is executed.

Thereafter, the DL site determined at the operation S906 is accessed by the CPU 201 (operation S907). Then, the series of processing operations for determining the DL site are ended.

Incidentally, although the case of determining the DL site by the client terminal 110 shown in FIG. 1 has been described in conjunction with FIG. 9, the DL site may well be determined by the Web server 120 instead of the client terminal 110.

Concretely, by way of example, the determination of the DL site by the Web server 120 may well be such that, when an access instruction from the client terminal 110 is accepted, the hypertext 401 in which the applet is incorporated is outputted to the client terminal 110 by the processing operations shown in FIGS. 7 and 8. Besides, in a case where the hypertext 401 has been selected, the applet is activated to determine the DL site.

As described above, in accordance with the embodiment of the invention, when a download request for contents is accepted by the selection of a hypertext, a DL site can be determined on the basis of the time of the selection and weights concerning downloads. Therefore, the loads of servers are appropriately dispersed, whereby the optimization of the download can be attained.

Besides, in accordance with the embodiment of the invention, the weights concerning the downloads can be set in accordance with the scheduled operations and performances of the servers. Therefore, the appropriate load dispersion can be attained in compliance with the intention of an information provider operating the DL sites. That is, the maintenances of the servers can be appropriately performed without exerting influence on a download environment.

Besides, in accordance with the embodiment of the invention, the DL site can be determined on the basis of the right most numeral of the seconds of the selection time and a numeral correspondent to the weight concerning the download. Therefore, the determination of the DL site can be made simple and precise.

Concretely, a processing load ascribable to a process for generating pseudo-random numbers in order to determine the DL site is dispensed with, and the deviation of a probability attributed to the process for generating the pseudo-random numbers can be prevented. Further, any process need not be executed by the server operating the DL site, so that the load on the server can be decreased.

Moreover, in accordance with the embodiment of the invention, a user merely selects a single hypertext in order to download contents, whereby he/she can access the DL site appropriately determined and download the contents. Accordingly, even in a case where the identical contents can be downloaded from the plurality of DL sites, the user can download the contents without being puzzled in the selection of a download destination. Besides, the display of an HP becomes simple and easy to see, by employing the single hypertext.

Incidentally, a download server determination method described in the embodiment can be implemented in such a way that a program prepared beforehand is run by a computer such as personal computer or workstation. The program is recorded in a computer-readable record medium such as hard disk, flexible disk, CD-ROM, MO or DVD, and it is run by being read out from the record medium by the computer. Besides, the program may well be a transfer medium which can be distributed through a network such as the Internet.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A download server determination method wherein a computer determines a download server from which contents are to be downloaded into a terminal device, from among a plurality of servers in which the identical contents are stored, comprising the operations of:
accepting a download request for the contents, from the terminal device;
detecting a time at which the download request was accepted; and
determining the download server in accordance with the detected time.

2. The download server determination method as defined in claim 1, wherein the determining operation determines the download server on the basis of numerals allotted to the respective servers, and the time.

3. The download server determination method as defined in claim 1, wherein the determining operation determines a server to which a numeral used for indicating the time is allotted, as the download server from among the plurality of servers.

4. The download server determination method as defined in claim 1, wherein the determining operation determines a server to which the right most numeral of the seconds of the time is allotted, as the download server from among the plurality of servers.

5. The download server determination method as defined in claim 4, wherein numbers which correspond to weights concerning downloads of the contents are allotted to the respective servers, as the numerals which are allotted to the respective servers.

6. The download server determination method as defined in claim 1, wherein the accepting operation accepts the download request by selection of a single hypertext concerning the download of the contents as is displayed by the terminal device.

7. The download server determination method as defined in claim 1, wherein the computer which executes the download server determination method is the terminal device.

8. The download server determination method as defined in claim 1, wherein the computer which executes the download server determination method is a computer of a Web server which manages the plurality of servers.

9. A computer-readable record medium bearing a program which causes a computer to execute a download server determination method wherein a download server from which contents are downloaded into a terminal device is determined from among a plurality of servers in which the identical contents are stored, the method comprising the operations of:
accepting a download request for the contents, from the terminal device;
detecting a time at which the download request was accepted; and
determining the download server in accordance with the detected time.

10. The computer-readable record medium bearing a program which causes a computer to execute a download server determination method as defined in claim 9, wherein the determining operation of the method determines the download server on the basis of numerals allotted to the respective servers, and the time.

11. The computer-readable record medium bearing a program which causes a computer to execute a download server determination method as defined in claim 9, wherein the determining operation of the method determines a server to which a numeral used for indicating the time is allotted, as the download server from among the plurality of servers.

12. The computer-readable record medium bearing a program which causes a computer to execute a download server determination method as defined in claim 9, wherein the determining operation of the method determines a server to which the right most numeral of the seconds of the time is allotted, as the download server from among the plurality of servers.

13. The computer-readable record medium bearing a program which causes a computer to execute a download server determination method as defined in claim 12, wherein in the method, numbers which correspond to weights concerning downloads of the contents are allotted to the respective servers, as the numerals which are allotted to the respective servers.

14. The computer-readable record medium bearing a program which causes a computer to execute a download server determination method as defined in claim 9, wherein the accepting operation of the method accepts the download request by selection of a single hypertext concerning the download of the contents as is displayed by the terminal device.

15. The computer-readable record medium bearing a program which causes a computer to execute a download server determination method as defined in claim 9, wherein the program recorded in the record medium is read by the terminal device, and the download server determination method is executed by the terminal device.

16. The computer-readable record medium bearing a program which causes a computer to execute a download server determination method as defined in claim 9, wherein the program recorded in the record medium is read by a computer of a Web server which manages the plurality of servers, and the download server determination method is executed by the computer.
